(19) United States
(12) Patent Application Publication
(10) Pub. No.: US 2020/0193278 A1
(43) Pub. Date: Jun. 18, 2020

(54) NEURAL PROCESSING SYSTEM AND OPERATING METHOD THEREOF

(71) Applicant: SAMSUNG ELECTRONICS CO., LTD., SUWON-SI (KR)

(72) Inventor: MINSU JEON, Seoul (KR)

(21) Appl. No.: 16/552,631

(22) Filed: Aug. 27, 2019

(30) Foreign Application Priority Data
Dec. 17, 2018 (KR) 10-2018-0163038

(51) Int. Cl. G06N 3/063

(52) U.S. Cl. CPC G06N 3/063

(57) ABSTRACT

A method of operating a neural processing system including a plurality of processing devices includes selecting a first processing device, which will perform processing based on a neural network, from among the plurality of processing devices based on state information of the plurality of processing devices. The method further includes, when at least one operator of the neural network is not supported by the first processing device, transforming the neural network into a transformed neural network based on first support operators that are supported by the first processing device. The method further includes performing, by the first processing device, the processing based on the transformed neural network.

### CROSS-REFERENCE TO RELATED APPLICATIONS

This application claims priority under 35 U.S.C. § 119 to Korean Patent Application No. 10-2018-0163038, filed on Dec. 17, 2018 in the Korean Intellectual Property Office, the disclosure of which is incorporated by reference herein in its entirety.

### TECHNICAL FIELD

Exemplary embodiments of the inventive concept relate to a neural processing system, and more particularly, to a neural processing system which performs neural processing by using various kinds of processing devices, and an operating method thereof.

### DISCUSSION OF THE RELATED ART

A neural processing system is a system that processes data based on a neural network. Neural processing may require the processing of a large amount of data. For this reason, various kinds of processing devices such as, for example, a central processing unit (CPU), a graphic processing unit (GPU), a neural processing unit (NPU), and a digital signal processor (DSP) may be used for efficient data processing. The processing devices may support different operators. As such, a processing device that will perform processing may be selected according to an operator to be performed.

### SUMMARY

Exemplary embodiments of the inventive concept provide a neural processing system which may improve processing performance by preventing the load from being focused on a specific processing device among various kinds of processing devices performing neural processing, and an operating method thereof.

According to an exemplary embodiment, a method of operating a neural processing system including a plurality of processing devices includes selecting a first processing device, which will perform processing based on a neural network, from among the plurality of processing devices based on state information of the plurality of processing devices. The method further includes, when at least one operator of the neural network is not supported by the first processing device, transforming the neural network into a transformed neural network based on first support operators that are supported by the first processing device. The method further includes performing, by the first processing device, the processing based on the transformed neural network.

According to an exemplary embodiment, a method of operating a neural processing system including a first processing device and a second processing device includes performing, by the first processing device, first neural processing based on a neural network. The method further includes, after performing the first neural processing, when a temperature of the first processing device exceeds a threshold value, transforming the neural network into a transformed neural network based on support operators that are supported by the second processing device. The method further includes performing, by the second processing device, second neural processing based on the transformed neural network.

According to an exemplary embodiment, a neural processing system includes a first processing device that supports first support operators, a second processing device that supports second support operators, a state information monitor that monitors state information of the first and second processing devices, and a neural processing controller that selects a processing device, which will perform processing input data based on a neural network, from among the first and second processing devices based on the state information. When at least one of operators of the neural network is not supported by the selected processing device, the neural processing controller transforms the neural network into a transformed neural network based on support operators of the selected processing device among the first support operators and the second support operators.

### BRIEF DESCRIPTION OF THE DRAWINGS

The above and other features of the present inventive concept will become more apparent by describing in detail exemplary embodiments thereof with reference to the accompanying drawings, in which:

FIG. 1 is a block diagram illustrating a neural processing system according to an exemplary embodiment of the inventive concept.

FIG. 2 is a flowchart illustrating an exemplary operation of the neural processing system of FIG. 1.

FIG. 3 is a diagram illustrating an example of support operators of a first processing device and a second processing device of FIG. 1.

FIG. 4A is a diagram illustrating an example of a neural network of FIG. 1.

FIG. 4B is a diagram illustrating an example of a neural network transformed from a neural network of FIG. 4A.

FIG. 5 is a block diagram illustrating a software structure of the neural processing system of FIG. 1 according to an exemplary embodiment of the inventive concept.

FIG. 6 is a block diagram illustrating a neural processing system according to an exemplary embodiment of the inventive concept.

FIG. 7 is a block diagram for describing an example in which the neural processing system of FIG. 1 selects a processing device based on temperature information.

FIG. 8 is a block diagram for describing an example in which the neural processing system of FIG. 1 selects a processing device based on voltage information.

FIG. 9 is a block diagram for describing an example in which the neural processing system of FIG. 1 selects a processing device based on current information.

FIG. 10 is a block diagram for describing an example in which the neural processing system of FIG. 1 selects a processing device based on clock frequency information.

FIG. 11 is a flowchart illustrating an exemplary operation of the neural processing system of FIG. 1.

FIG. 12 is a block diagram for describing an example in which a neural processing system of FIG. 1 performs an operation of FIG. 11.

FIG. 13 is a block diagram illustrating a system on chip according to an exemplary embodiment of the inventive concept.

FIG. 14 is a block diagram illustrating a portable terminal according to an exemplary embodiment of the inventive concept.

### DETAILED DESCRIPTION

Exemplary embodiments of the inventive concept will be described more fully hereinafter with reference to the accompanying drawings. Like reference numerals may refer to like elements throughout the accompanying drawings.

It will be understood that the terms “first,” “second,” “third,” etc. are used herein to distinguish one element from another, and the elements are not limited by these terms. Thus, a “first” element in an exemplary embodiment may be described as a “second” element in another exemplary embodiment.

It will be further understood that descriptions of features or aspects within each exemplary embodiment should typically be considered as available for other similar features or aspects in other exemplary embodiments, unless the context clearly indicates otherwise.

Herein, a neural network may be a network that models a brain function of a human to process data. A brain of a human may transfer a signal from one neuron to another neuron through a synapse between neurons. A connection relationship of the neurons and the synapses may be implemented with a neural network. In this case, a neuron may correspond to a node of a graph, and a synapse may correspond to a line connecting a node to another node. Accordingly, the neural network may include parameters indicating connection information of a graph.

Herein, neural processing means an operation of processing data based on the neural network. That is, the neural processing may indicate performing various operations on data based on parameters included in a neural network.

In a case in which a specific neural network for neural processing is given, the specific neural network may require the performing of a specific operator. In this case, a processing device, which supports the specific operator, from among various kinds of processing devices may be selected to perform the specific operator. In the case in which neural processing based on the specific neural network is repeated, the load may be focused on one processing device. In this case, processing performance of that one processing device may be reduced due to, for example, the heat generated at the processing device. As a result, processing performance may be degraded, and the processing device may be damaged.

However, in a conventional neural processing system, since the processing devices other than the selected processing device may not support the specific operator, the selected processing device may be forced to continue the processing since there are no other options available, even though this may degrade performance and damage the selected processing device. For example, assume a conventional neural processing system includes only one central processing unit (CPU) and one graphic processing unit (GPU) as processing devices, and that only the CPU is capable of performing a specific required operator. In such a conventional neural processing system, the CPU would be forced to continue the processing since it is the only processing device capable of doing so, which may degrade performance and may damage the CPU.

Exemplary embodiments of the inventive concept improve upon such a conventional neural processing system by taking states of the processing devices in the neural processing system into consideration, and by implementing a transformation process that transforms a current neural network into a transformed neural network that allows for the load to be distributed among different processing devices, even if these different processing devices do not support the required operator, as described in further detail below.

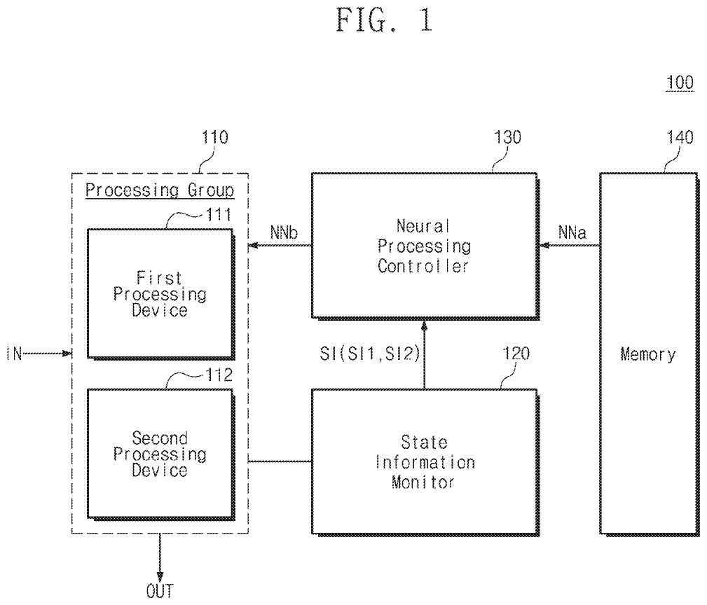

FIG. 1 is a block diagram illustrating a neural processing system 100 according to an exemplary embodiment of the inventive concept. The neural processing system 100 may be implemented with various kinds of electronic devices or electronic circuits that may process data based on a neural network. For example, the neural processing system 100 may be implemented with a desktop computer, a laptop computer, a tablet computer, a smartphone, a wearable device, an Internet of Things (IoT) device, an electric vehicle, a workstation, a server system, an integrated circuit (IC), a motherboard, a system on chip (SoC), a microprocessor, an application processor (AP), or a semiconductor chipset. However, the inventive concept is not limited thereto. For example, the neural processing system 100 may be implemented with any kind of device or circuit that processes data based on a neural network.

The neural processing system 100 may include a processing group 110, a state information monitor 120, a neural processing controller 130, and a memory 140. The neural processing controller 130 may also be referred to herein as a neural processing controller circuit.

The processing group 110 may perform neural processing based on a neural network NNb provided from the neural processing controller 130. The processing group 110 may process input data IN based on the neural network NNb to output result data OUT. For example, the processing group 110 may receive image data as the input data IN. The processing group 110 may perform the neural processing to identify an object included in the image data.

The processing group 110 may output the identified object information as the result data OUT. That is, the processing group 110 may perform an inference on the input data IN.

The processing group 110 may include a first processing device 111 and a second processing device 112. In an exemplary embodiment, one of the first processing device 111 or the second processing device 112 may perform neural processing based on the neural network NNb. A processing device that will perform the neural processing may be selected by the neural processing controller 130. The selected processing device may process the input data IN and may output the result data OUT.

The first processing device 111 and the second processing device 112 may be devices that support various kinds of operators to perform various operations. An operator may indicate various kinds of operations or operational functions that may be performed for neural network-based data processing. For example, the operator may include a convolution (CONV) operation, a multiplication (MUL) operation, an addition (ADD) operation, an accumulation (ACC) operation, activation functions (e.g., ReLU and TANH), a SOFTMAX function, a fully connected (FC) operation, a MAXPOOLING operation, a recurrent neural network (RNN) operation, etc. However, the inventive concept is not limited thereto.

For example, each of the first processing device 111 and the second processing device 112 may be one of a central processing unit (CPU), a graphic processing unit (GPU), a neural processing unit (NPU), and a digital signal processor (DSP). However, the inventive concept is not limited thereto. Each of the first processing device 111 and the second processing device 112 may be implemented with any kind of operation device that may perform data processing. For example, the first processing device 111 and the second processing device 112 may be different kinds of processing devices. However, the inventive concept is not limited thereto.

An operator that is supported (hereinafter referred to as a “support operator”) by the first processing device 111 may be different from an operator that is supported by the second processing device 112. For example, at least one of support operators of the first processing device 111 may not be included in support operators of the second processing device 112. In the case in which the first processing device 111 and the second processing device 112 are different kinds of processing devices, a support operator of the first processing device 111 may be different from a support operator of the second processing device 112. However, the inventive concept is not limited thereto. For example, even though the first processing device 111 and the second processing device 112 are processing devices of the same kind, a support operator of the first processing device 111 may be different from a support operator of the second processing device 112.

Each of the first processing device 111 and the second processing device 112 may operate based on its own support operator. In an exemplary embodiment, each of the first processing device 111 and the second processing device 112 may fail to support an operator different from its own support operator. For example, for neural processing based on the neural network NNb, in the case in which the performing of an operator that the first processing device 111 does not support is required, the first processing device 111 may fail to perform the neural processing based on the neural network NNb.

As illustrated in FIG. 1, the processing group 110 may include the first and second processing devices 111 and 112. However, the inventive concept is not limited thereto. For example, the processing group 110 may include various numbers of processing devices. Below, for convenience of description, it is assumed that the neural processing system 100 includes the two processing devices 111 and 112.

The state information monitor 120 may monitor state information SI of the processing group 110. The state information SI may include various information which has an influence on the operating performance of the first and second processing devices 111 and 112. For example, the state information SI may include at least one of a temperature of the first processing device 111, a voltage and current to be provided to the first processing device 111, and a frequency of a clock to be provided to the first processing device 111.

The state information monitor 120 may include a sensor that may directly obtain the state information SI, and may also collect sensing information provided from separate sensors. In this case, the state information monitor 120 may output the state information SI based on the sensing information. For example, in the case in which the sensing information is changed, the state information monitor 120 may output the updated state information SI.

The state information monitor 120 may monitor first state information SI1 of the first processing device 111, and may monitor second state information SI2 of the second processing device 112. The first state information SI1 and the second state information SI2 may be different from each other, depending on operation states of the first processing device 111 and the second processing device 112. The state information monitor 120 may provide the first state information SI1 and the second state information SI2 to the neural processing controller 130.

The state information monitor 120 may accumulate and manage the state information SI. For example, the state information monitor 120 may store the state information SI by using a separate table and may check a change of the state information SI over time. Various information such as, for example, deterioration probability of the first processing device 111 and the second processing device 112, may be determined based on the change of the state information SI over time.

The neural processing controller 130 may select a processing device, which will perform the neural processing, based on the provided state information SI. For example, based on the state information SI, the neural processing controller 130 may select a processing device other than a processing device that has a probability that operating performance is reduced. The neural processing controller 130 may request neural processing based on the neural network NNb to the selected processing device.

The neural processing controller 130 may receive a neural network NNa from the memory 140. For example, the neural network NNa may include parameters indicating graph connection information and learned parameters (e.g., a weight and a bias). The neural processing controller 130 may analyze the neural network NNa. As such, the neural processing controller 130 may determine operators to be performed upon performing the neural processing based on the neural network NNa.

The neural processing controller 130 may create the neural network NNb from the neural network NNa based on the determined operators of the neural network NNa. In the case in which the operators of the neural network NNa are included in support operators of the selected processing device, the neural processing controller 130 may create the neural network NNb to be identical to the neural network NNa. In the case in which at least one of the operators of the neural network NNa is not included in the support operators of the selected processing device, the neural processing controller 130 may transform the neural network NNa to create the neural network NNb. That is, the neural processing controller 130 may create the neural network NNb by using the neural network NNa without modification or may transform the neural network NNa to create the neural network NNb.

For example, in the case in which a first operator of the operators of the neural network NNa is not included in the support operators of the selected processing device, the neural processing controller 130 may transform the neural network NNa such that the first operator is transformed to at least one of the support operators of the selected processing device. In this case, the at least one operator transformed may provide the same operation result with regard to the same input as the first operator. The operator of the neural network NNb transformed may be included in the support operators of the selected processing device. Accordingly, the selected processing device may perform the neural processing without a problem associated with an operator (e.g., an unsupported operator).

The neural processing controller 130 may provide the neural network NNb to one of the first processing device 111 or the second processing device 112. A processing device that receives the neural network NNb may perform the neural processing based on the neural network NNb.

As illustrated in FIG. 1, the neural processing controller 130 may be implemented with a controller independent of the processing group 110. However, the inventive concept is not limited thereto. For example, the neural processing controller 130 may be included in one of the first and second processing devices 111 and 112. In this case, a processing device including the neural processing controller 130 may select a processing device that will perform the neural processing and may directly perform the neural processing as well as the conversion of the neural network NNa.

The memory 140 may store the neural network NNa. For example, the memory 140 may include a volatile memory, such as a dynamic random access memory (DRAM) or a synchronous DRAM (SDRAM), and/or a nonvolatile memory, such as a phase-change RAM (PRAM), a magneto-resistive RAM (MRAM), a resistive RAM (ReRAM), or a ferroelectric RAM (FRAM). However, the inventive concept is not limited thereto.

As described above, the neural processing controller 130 may select a processing device, which will perform the neural processing, in consideration of the state information SI of each of the processing devices 111 and 112. The neural processing controller 130 may transform the neural network NNa such that the selected processing device may perform the neural processing. In this case, the neural network NNa may be transformed based on the support operators of the selected processing device. The selected processing device may perform the neural processing based on the transformed neural network NNb. Accordingly, the neural processing system 100 may perform the neural processing by using a plurality of processing devices 111 and 112 without a limitation on support operators.

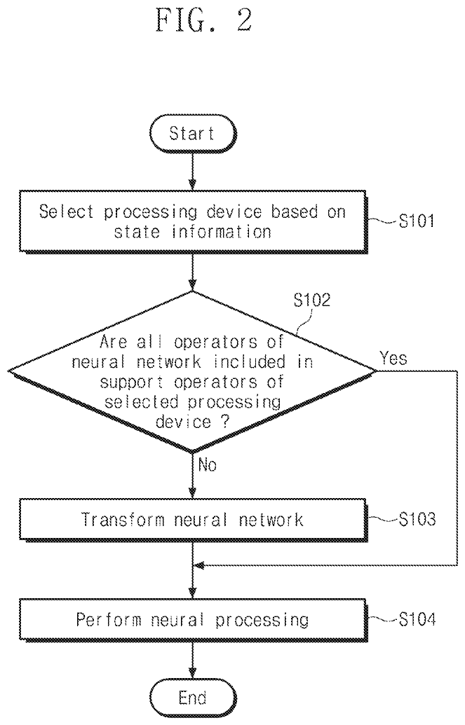

FIG. 2 is a flowchart illustrating an exemplary operation of the neural processing system 100 of FIG. 1.

Referring to FIGS. 1 and 2, in operation S101, the neural processing system 100 may select a processing device based on the state information SI of each of the processing devices 111 and 112. In an exemplary embodiment, the neural processing system 100 may select a processing device in consideration of the support operators of each of the processing devices 111 and 112 as well as the state information SI. For example, in the case in which the state information SI of the processing devices 111 and 112 are substantially the same, the neural processing system 100 may consider support operators. State information SI may be substantially the same when, for example, the state information SI are identical to each other, indistinguishable from each other, or distinguishable from each other but functionally the same as each other as would be understood by a person having ordinary skill in the art. For example, the state information SI may be substantially the same when values of the state information SI are equal to each other to within a measurement error, or if measurably unequal, are close enough in value to be functionally equal to each other as would be understood by a person having ordinary skill in the art.

The neural processing system 100 may select a processing device, which may perform support operators including all the operators of the neural network NNa, from among the processing devices 111 and 112. Alternatively, the neural processing system 100 may select a processing device including support operators to which an operator of the neural network NNa may be transformed. For example, in the case in which a processing device that may perform the first operator of the neural network NNa is absent, the neural processing system 100 may select a processing device including support operators to which the first operator may be transformed.

In operation S102, the neural processing system 100 may determine whether all operators of the neural network NNa are included in support operators of the selected processing device. The neural processing system 100 may store information about the support operators of each of the processing devices 111 and 112 in advance. The neural processing system 100 may compare the operators of the neural network NNa with the support operators of the selected processing device.

When a comparison result indicates that at least one of the operators of the neural network NNa is not included in the support operators, in operation S103, the neural processing system 100 may transform the neural network NNa. The neural processing system 100 may transform the neural network NNa such that all of the operators of the neural network NNa are included in the support operators. As such, the neural processing system 100 may create the neural network NNb that is different from the neural network NNa. In operation S104, the neural processing system 100 may perform the neural processing based on the neural network NNb. The neural processing system 100 may perform the neural processing through the selected processing device.

In an exemplary embodiment, when the comparison result indicates that all of the operators of the neural network NNa are included in the support operators, the neural processing system 100 does not transform the neural network NNa. As such, the neural processing system 100 may create the neural network NNb that is identical to the neural network NNa. In operation S104, the neural processing system 100 may perform the neural processing based on the neural network NNb. The neural processing system 100 may perform the neural processing through the selected processing device.

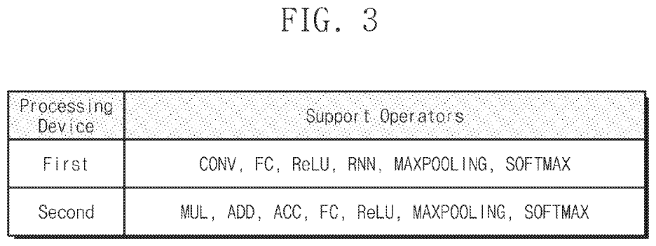

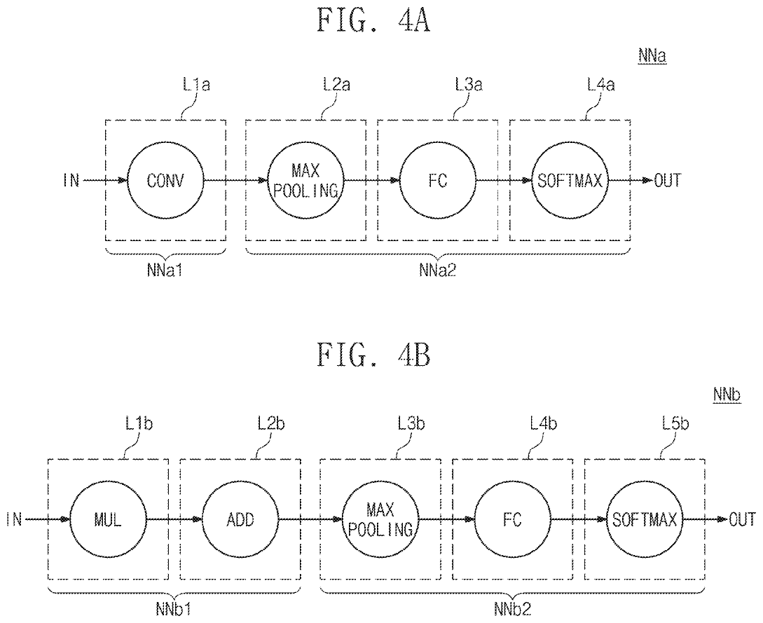

Below, an operation of the neural processing controller 130 of FIG. 1 will be more fully described with reference to FIGS. 3, 4A and 4B. For convenience of description, it is assumed that the neural processing controller 130 selects the second processing device 112 based on the state information SI.

FIG. 3 is a diagram illustrating an example of support operators of the first processing device 111 and the second processing device 112 of FIG. 1. In an exemplary embodiment, information about support operators of FIG. 3 may be managed in the form of a table that the neural processing controller 130 may refer to. However, the inventive concept is not limited thereto.

Referring to FIGS. 1 and 3, the first processing device 111 may support a convolution (CONV) operation, a fully connected (FC) operation, an activation function (e.g., ReLU), a recurrent neural network (RNN) operation, a MAXPOOLING operation, and a SOFTMAX function. The second processing device 112 may support a multiplication (MUL) operation, an addition (ADD) operation, an accumulation (ACC) operation, a fully connected (FC) operation, an activation function (e.g., ReLU), a MAXPOOLING operation, and a SOFTMAX function.

At least one of the support operators of the first processing device 111 may not be included in the support operators of the second processing device 112. Similarly, at least one of the support operators of the second processing device 112 may not be included in the support operators of the first processing device 111. For example, in the example illustrated in FIG. 3, the convolution (CONV) operation of the first processing device 111 is not included in the support operators of the second processing device 112.

The neural processing controller 130 may store information about the support operators of FIG. 3 in advance. For example, in an initialization operation of the neural processing system 100, the neural processing controller 130 may receive and store the information about the support operators from the respective processing devices 111 and 112.

FIG. 4A is a diagram illustrating an example of the neural network NNa of FIG. 1. FIG. 4B is a diagram illustrating an example of the neural network NNb transformed from the neural network NNa of FIG. 4A.

Referring to FIG. 4A, the neural network NNa may include layers corresponding to various kinds of operators. For example, the neural network NNa may include a first layer L1a corresponding to the convolution (CONV) operation, a second layer L2a corresponding to the MAXPOOLING operation, a third layer L3a corresponding to the fully connected (FC) operation, and a fourth layer L4a corresponding to the SOFTMAX function. The neural network NNa may be, for example, a convolutional neural network (CNN). However, the inventive concept is not limited thereto.

Referring to FIG. 4B, the neural network NNb may include layers corresponding to various kinds of operators. For example, the neural network NNb may include a first layer Llb corresponding to the multiplication (MUL) operation, a second layer L2b corresponding to the addition (ADD) operation, a third layer L3b corresponding to the MAXPOOLING operation, a fourth layer L4b corresponding to the fully connected (FC) operation, and a fifth layer L5b corresponding to the SOFTMAX function.

Referring to FIGS. 1, 3, 4A and 4B, the neural processing controller 130 may analyze the neural network NNa to determine the operators included in the neural network NNa. According to the above description, the neural processing controller 130 may determine that the operators CONV, MAXPOOLING, FC, and SOFTMAX are included in the neural network NNa.

The neural processing controller 130 may compare the operators determined to be included in the neural network NNa with the support operators of the selected processing device (e.g., the second processing device 112). The neural processing controller 130 may determine that the convolution (CONV) operation of the neural network NNa is not included in the support operators of the second processing device 112. As such, the neural processing controller 130 may transform the neural network NNa such that the convolution (CONV) operation may be transformed to at least one of the support operators of the second processing device 112. Thus, the neural processing controller 130 may transform only the first layer L1a, which corresponds to the convolution (CONV) operation, of the neural network NNa.

The neural processing controller 130 may transform the first layer L1a of the neural network NNa to create first and second layers Llb and L2b of the neural network NNb. Graph connection information of the first and second layers Llb and L2b respectively corresponding to the multiplication (MUL) and addition (ADD) operations may be generated from the graph connection information of the first layer L1a corresponding to the convolution (CONV) operation. That is, the neural processing controller 130 may generate the graph connection information of the first and second layers Llb and L2b based on the graph connection information of the first layer L1a. In this case, the first and second layers Llb and L2b respectively corresponding to the multiplication (MUL) and addition (ADD) operations may provide the same operation result with regard to the same input as the first layer L1a. For example, the first and second layers Llb and L2b may together perform the same function as the first layer L1a.

The neural processing controller 130 may provide the neural network NNb to the second processing device 112. The second processing device 112 may process the input data IN based on the neural network NNb to output the result data OUT. For example, the second processing device 112 may extract feature data associated with the input data IN through the multiplication (MUL) operation and the addition (ADD) operation. The second processing device 112 may perform sampling on the extracted feature data through the MAXPOOLING operation. The sampled data may be a maximum value of the feature data. The second processing device 112 may reduce a dimension of the feature data through the fully connected (FC) operation. For example, the second processing device 112 may reduce two-dimensional feature data to one-dimensional feature data through the activation function. The second processing device 112 may estimate maximum likelihood through the SOFTMAX function. As such, the second processing device 112 may output a value corresponding to the maximum likelihood as the result data OUT.

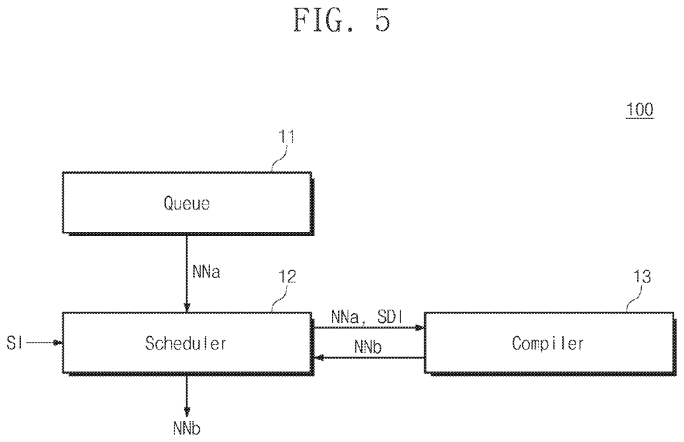

FIG. 5 is a block diagram illustrating a software structure of the neural processing system 100 of FIG. 1 according to an exemplary embodiment of the inventive concept.

Referring to FIG. 5, the neural processing system 100 may include a queue 11, a scheduler 12, and a compiler 13.

The queue 11 is a data structure that may receive and output a neural network. Various neural networks for various neural processing may be stored in the queue 11. In this case, the queue 11 may store neural networks such that a neural network associated with neural processing to be first performed is first processed. Some of the neural networks stored in the queue 11 may be identical. Alternatively, some of the neural networks stored in the queue 11 may be different from each other. The queue 11 may be implemented using the memory 140 of FIG. 1.

The scheduler 12 may fetch the neural network NNa to be processed from the queue 11. In the case in which various neural networks are stored in the queue 11, the scheduler 12 may fetch the neural network NNa in the order of a neural network stored in the queue 11. The scheduler 12 may select a processing device, which will perform the neural processing, based on the state information SI of processing devices. After selecting the processing device, the scheduler 12 may provide the neural network NNa and information SDI about the selected processing device to the compiler 13.

The compiler 13 may determine whether the selected processing device is capable of performing processing based on the neural network NNa, with reference to information about support operators for each processing device. In the case in which the support operators of the selected processing device include all of the operators of the neural network NNa, the compiler 13 may determine that the selected processing device is capable of performing the processing. In this case, the compiler 13 may provide the neural network NNb, which is identical to the neural network NNa, to the scheduler 12.

Herein, when a processing device is described as being capable of performing processing based on a neural network, it is to be understood that the processing device supports the operator(s) included in the neural network. For example, a processing device is capable of performing processing based on a neural network when the processing device includes the operators included in the neural network.

In the case in which the support operators of the selected processing device do not include at least one of the operators of the neural network NNa, the compiler 13 may determine that the selected processing device is unable to perform the processing. In this case, the compiler 13 may transform an operator not included in the support operators among the operators of the neural network NNa, as described above with reference to FIGS. 4A and 4B. The transformed operator may be included in the support operators of the selected processing device. As such, the compiler 13 may transform the neural network NNa to create the neural network NNb, which is different from the neural network NNa. The compiler 13 may provide the neural network NNb to the scheduler 12.

The scheduler 12 may provide the neural network NNb to the selected processing device. The selected processing device may perform the neural processing based on the neural network NNb. The neural processing system 100 may repeatedly operate in the above manner until the queue 11 becomes empty.

The scheduler 12 and the compiler 13 may be implemented using software that is stored in an internal memory or an external memory of the neural processing controller 130. The scheduler 12 and the compiler 13 may be driven by the neural processing controller 130.

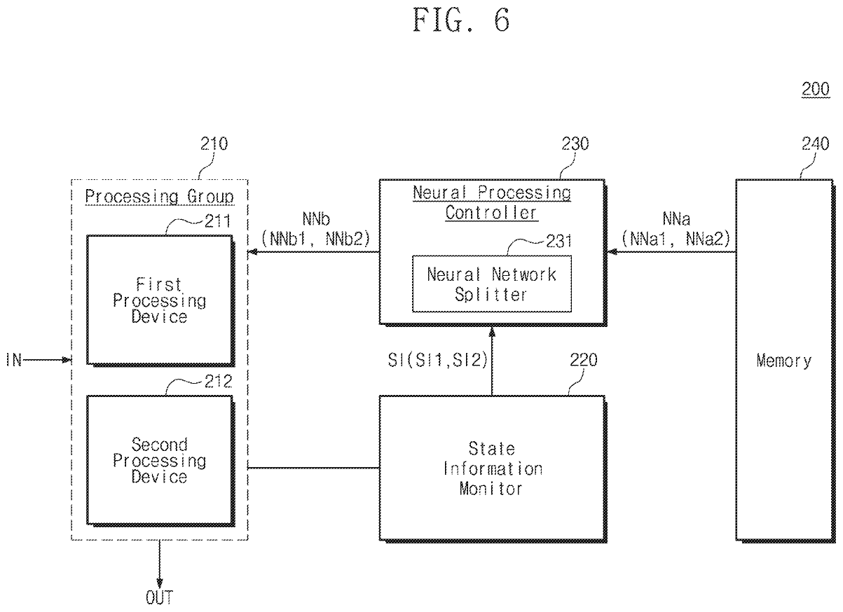

FIG. 6 is a block diagram illustrating a neural processing system 200 according to an exemplary embodiment of the inventive concept.

The neural processing system 200 may include a processing group 210, a state information monitor 220, a neural processing controller 230, and a memory 240. Operations of the processing group 210, the state information monitor 220, the neural processing controller 230, and the memory 240 illustrated in FIG. 6 are similar to the operations of the processing group 110, the state information monitor 120, the neural processing controller 130, and the memory 140 illustrated in FIG. 1. Thus, for convenience of explanation, a further description of elements and technical aspects previously described will be omitted, and an operation the neural processing system 200 of FIG. 6 will be described with focus on the differences between the neural processing system 100 of FIG. 1 and the neural processing system 200 of FIG. 6.

The neural processing controller 230 may select a processing device, which will perform the neural processing, based on the state information SI. The neural processing controller 230 may select a different processing device for each neural processing phase. For example, the neural processing controller 230 may schedule a neural processing task such that partial neural processing of the entire neural processing is performed through a second processing device 212 and the remaining neural processing is performed through a first processing device 211.

Below, an operation of the neural processing controller 230 of FIG. 6 will be more fully described with reference to FIGS. 3, 4A and 4B.

Referring to FIGS. 3, 4A, 4B and 6, the neural processing controller 230 may split the neural network NNa into first and second neural networks NNa1 and NNa2 through a neural network splitter 231. For example, the neural network splitter 231 may split the neural network NNa in the unit of an operator. The neural processing controller 230 may schedule a processing work such that the second processing device 212 performs first processing based on the first neural network NNa1 and the first processing device 211 performs second processing based on the second neural network NNa2. That is, the neural processing work may be allocated to the first processing device 211 and the second processing device 212.

Before the second processing device 212 performs the first processing based on the first neural network NNa1, the neural processing controller 230 may analyze the first neural network NNa1 to determine which operators are included in the first neural network NNa1. For example, the neural processing controller 230 may analyze the first neural network NNa1 and determine that the first neural network NNa1 includes an operator CONV.

The neural processing controller 230 may compare the identified operator (e.g., operator CONV) included in the first neural network NNa1 with support operators that are supported by the second processing device 212. For example, the neural processing controller 230 may determine whether the identified operator is supported by the second processing device 212. The neural processing controller 230 may determine that the convolution (CONV) operation of the first neural network NNa1 is not included in the support operators of the second processing device 212 (e.g., is not supported by the second processing device 212). As such, the neural processing controller 230 may transform the first neural network NNa1 such that the convolution (CONV) operation may be transformed to at least one of the support operators that are supported by the second processing device 212. For example, the neural processing controller 230 may transform the first neural network NNa1 to create a first neural network NNb1 of the neural network NNb, which includes a operator(s) supported by the second processing device 212. The neural processing controller 230 may provide the first neural network NNb1 to the second processing device 212. The second processing device 212 may process the multiplication (MUL) operation and the addition (ADD) operation on the input data IN based on the first neural network NNb1. Thus, by way of the transformation, the second processing device 212 may perform the desired function corresponding to the first neural network NNa1 even though the second processing device 212 does not support the operator included in the first neural network NNa1.

Before the first processing device 211 performs the second processing based on the second neural network NNa2, the neural processing controller 230 may analyze the second neural network NNa2 to determine which operators are included in the second neural network NNa2. For example, the neural processing controller 230 may determine that the operators MAXPOOLING, FC, and SOFTMAX are included in the second neural network NNa2.

The neural processing controller 230 may compare the identified operators included in the second neural network NNa2 with support operators of the first processing device 211 (e.g., support operators supported by the first processing device 211). The neural processing controller 230 may determine that the operators of the second neural network NNa2 are included in the support operators of the first processing device 211. As such, the neural processing controller 230 may create a second neural network NNb2 of the neural network NNb, which is identical to the second neural network NNa2. The neural processing controller 230 may provide the second neural network NNb2 to the first processing device 211. The first processing device 211 may perform the second processing by using data output as a result of the operation of the second processing device 212. The first processing device 211 may perform the second processing based on the second neural network NNb2 to output the result data OUT.

According to the neural processing system 100 of FIG. 1, in an exemplary embodiment, all neural processing may be performed by one processing device selected from a plurality of processing devices. According to the neural processing system 200 of FIG. 6, in an exemplary embodiment, one neural processing operation may be split into a plurality of processing operations so as to be performed by a plurality of processing devices. As such, the neural processing system 200 may split and allocate a neural processing operation among a plurality of processing devices, thus performing neural processing efficiently.

Below, for convenience of description, operations of a neural processing system according to exemplary embodiments of the inventive concept will be further described with reference to the neural processing system 100 of FIG. 1. However, it is to be understood that the description may also be applied to the neural processing system 200 of FIG. 6.

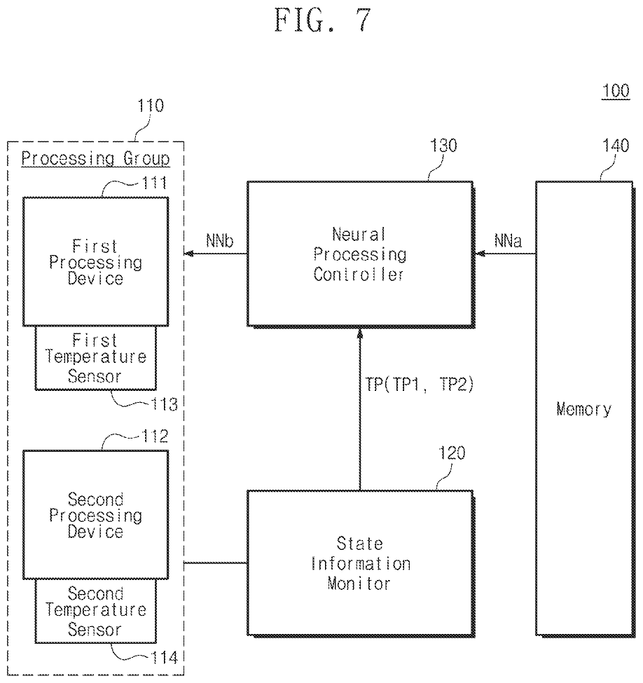

FIG. 7 is a block diagram for describing an example in which the neural processing system 100 of FIG. 1 selects a processing device based on temperature information.

Referring to FIG. 7, a first temperature sensor 113 may sense a temperature of the first processing device 111, and a second temperature sensor 114 may sense a temperature of the second processing device 112. The sensed temperature may be provided to the state information monitor 120. The state information monitor 120 may monitor a temperature of the processing group 110. The state information monitor 120 may provide temperature information TP1 of the first processing device 111 and temperature information TP2 of the second processing device 112 to the neural processing controller 130. Thus, in the example of FIG. 7, the first state information SI1 corresponds to the temperature information TP1, and the second state information SI2 corresponds to the second temperature information TP2.

The neural processing controller 130 may select one of the first processing device 111 or the second processing device 112 based on the temperature information TP. For example, in the case in which the temperature information TP1 of the first processing device 111 exceeds a threshold value, the neural processing controller 130 may select the second processing device 112. In this case, the threshold value may be a reference temperature at which the probability that operating performance of the first processing device 111 is reduced exists. That is, the threshold value may indicate a temperature at which the operating performance of the first processing device 111 is likely to be decreased. In the case in which neural processing is performed by the first processing device 111 in a state in which the temperature of the first processing device 111 exceeds the threshold value, a processing speed may decrease, and the temperature information TP1 of the first processing device 111 may be further increased. In this case, the first processing device 111 may be damaged. In the case in which neural processing is performed by the second processing device 112, the load may be appropriately distributed, and thus, the temperature of the first processing device 111 may again be decreased. Accordingly, neural processing may be consistently performed without reduction of the operating performance, and without causing damage to the first processing device 111.

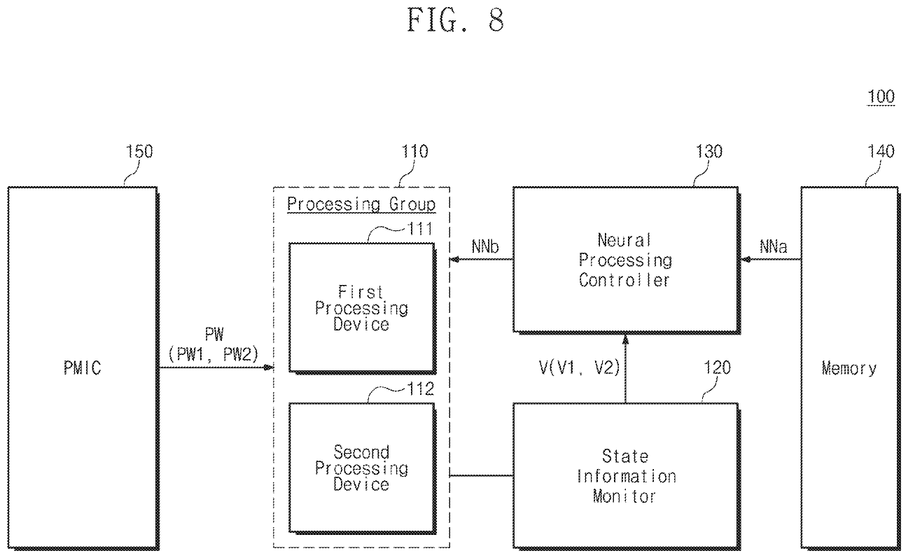

FIG. 8 is a block diagram for describing an example in which the neural processing system 100 of FIG. 1 selects a processing device based on voltage information.

Referring to FIG. 8, the neural processing system 100 may further include a power management integrated circuit (PMIC) 150. The PMIC 150 may supply power PW for an operation of the processing group 110. For example, the PMIC 150 may provide power PW1 to the first processing device 111 based on an operation state of the first processing device 111, and may provide power PW2 to the second processing device 112 based on an operation state of the second processing device 112. For example, in the case in which the load of the first processing device 111 increases, the PMIC 150 may increase the power PW1 that is supplied to the first processing device 111. Similarly, in the case in which the load of the second processing device 112 increases, the PMIC 150 may increase the power PW2 that is supplied to the second processing device 112.

The state information monitor 120 may monitor a voltage of the processing group 110. The state information monitor 120 may monitor a first voltage provided to the first processing device 111 from the PMIC 150 and a second voltage provided to the second processing device 112 from the PMIC 150. The state information monitor 120 may provide the voltage information V1 of the first processing device 111 and the voltage information V2 of the second processing device 112 to the neural processing controller 130. Thus, in the example of FIG. 8, the first state information SI1 corresponds to the voltage information V1, and the second state information SI2 corresponds to the voltage information V2.

The neural processing controller 130 may select one of the first processing device 111 or the second processing device 112 based on the voltage information V. For example, in the case in which the voltage information V1 of the first processing device 111 exceeds a threshold value, the neural processing controller 130 may select the second processing device 112. In this case, the threshold value may be a reference voltage at which the probability that operating performance of the first processing device 111 is reduced exists. That is, the threshold value may indicate a voltage at which the operating performance of the first processing device 111 is likely to be decreased. In the case in which neural processing is performed by the first processing device 111 in a state in which the voltage of the first processing device 111 exceeds the threshold value, power consumption may increase. Also, as the temperature of the first processing device 111 increases, the first processing device 111 may be damaged. In the case in which neural processing is performed by the second processing device 112, the load may be appropriately distributed, and thus, excessive power may not be supplied. As such, the neural processing system 100 may operate with low power, preventing a decrease in performance and reducing the likelihood of the first processing device 111 being damaged.

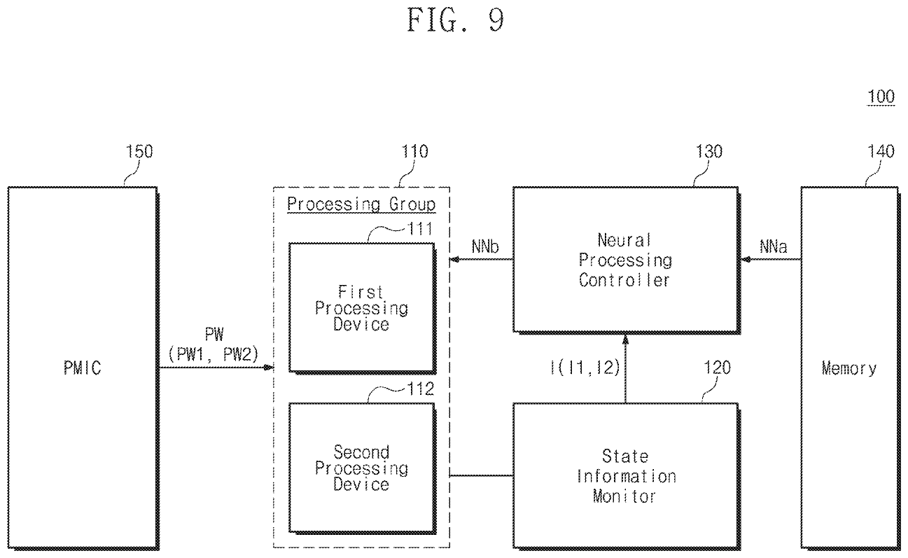

FIG. 9 is a block diagram for describing an example in which the neural processing system 100 of FIG. 1 selects a processing device based on current information.

Referring to FIG. 9, the neural processing system 100 may include the PMIC 150 described with reference to FIG. 8. The state information monitor 120 may monitor a current of the processing group 110. For example, the state information monitor 120 may monitor a current flowing through the first processing device 111 based on the power PW1 provided from the PMIC 150, and may monitor a current flowing through the second processing device 112 based on the power PW2 provided from the PMIC 150. The state information monitor 120 may provide the current information I1 of the first processing device 111 and the current information 12 of the second processing device 112 to the neural processing controller 130. Thus, in the example of FIG. 9, the first state information SI1 corresponds to the current information I1, and the second state information SI2 corresponds to the current information 12.

The neural processing controller 130 may select one of the first processing device 111 or the second processing device 112 based on the current information I. For example, in the case in which the current information I1 of the first processing device 111 exceeds a threshold value, the neural processing controller 130 may select the second processing device 112. In this case, the threshold value may be a reference current at which the probability that operating performance of the first processing device 111 is reduced exists. That is, the threshold value may indicate a current at which the operating performance of the first processing device 111 is likely to be decreased. In the case in which neural processing is performed by the first processing device 111 in a state in which the current of the first processing device 111 exceeds the threshold value, power consumption may increase. Also, as the temperature of the first processing device 111 increases, the first processing device 111 may be damaged. In the case in which neural processing is performed by the second processing device 112, the load may be appropriately distributed, and thus, an excessive power may not be supplied. As such, the neural processing system 100 may operate with a low power, preventing a decrease in performance and reducing the likelihood of the first processing device 111 being damaged.

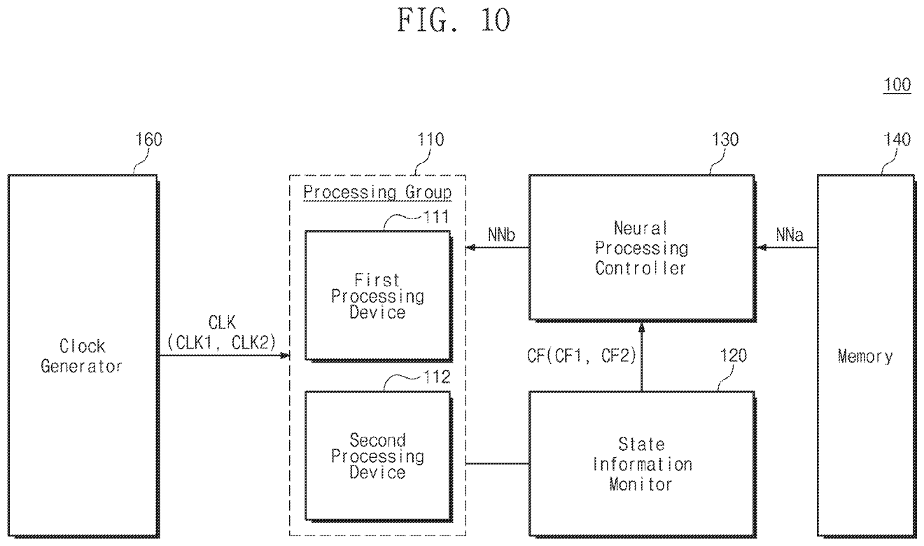

FIG. 10 is a block diagram for describing an example in which the neural processing system 100 of FIG. 1 selects a processing device based on clock frequency information.

Referring to FIG. 10, the neural processing system 100 may further include a clock generator 160. The clock generator 160 may supply a clock signal CLK for an operation of the processing group 110. The clock generator 160 may provide a clock signal CLK1 to the first processing device 111 based on an operation state of the first processing device 111, and may provide a clock signal CLK2 to the second processing device 112 based on an operation state of the second processing device 112. For example, in the case in which the load of the first processing device 111 increases, the clock generator 160 may increase a frequency of the clock signal CLK1. The clock generator 160 may be, for example, a phase locked loop (PLL) or a delay locked loop (DLL).

The state information monitor 120 may monitor a clock frequency of the processing group 110. The state information monitor 120 may monitor a clock frequency of the first processing device 111 and a clock frequency of the second processing device 112. The state information monitor 120 may provide clock frequency information CF1 of the first processing device 111 and clock frequency information CF2 of the second processing device 112 to the neural processing controller 130. Thus, in the example of FIG. 10, the first state information SI1 corresponds to the clock frequency information CF1, and the second state information SI2 corresponds to the clock frequency information CF2.

The neural processing controller 130 may select one of the first processing device 111 or the second processing device 112 based on the clock frequency information CF1 and CF2. For example, in the case in which the clock frequency information CF1 of the first processing device 111 exceeds a threshold value, the neural processing controller 130 may select the second processing device 112. In this case, the threshold value may be a reference frequency at which the probability that operating performance of the first processing device 111 is reduced exists. That is, the threshold value may indicate a clock frequency at which the operating performance of the first processing device 111 is likely to be decreased. In the case in which neural processing is performed by the first processing device 111 in a state in which the clock frequency of the first processing device 111 exceeds the threshold value, power consumption may increase as the clock frequency increases. Also, as the temperature of the first processing device 111 increases, the first processing device 111 may be damaged. In the case in which neural processing is performed by the second processing device 112, the load may be appropriately distributed. As such, the neural processing system 100 may operate with a low power, preventing a decrease in performance and reducing the likelihood of the first processing device being damaged.

Although FIGS. 7 to 10 illustrate examples in which the neural processing system 100 selects a processing device based on one of a temperature, a voltage, a current, or a clock frequency, it is to be understood that the inventive concept is not limited thereto. For example, in exemplary embodiments, the neural processing system 100 may select a processing device based on two or more of various pieces of state information. For example, exemplary embodiments may utilize one or more of a temperature, a voltage, a current, or a clock frequency to select a processing device, as well as other factors.

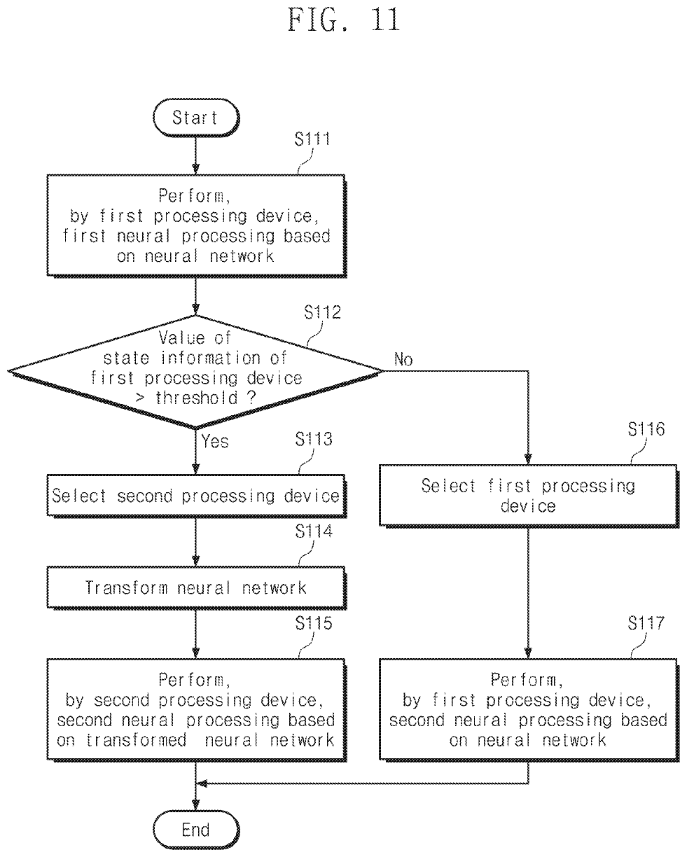

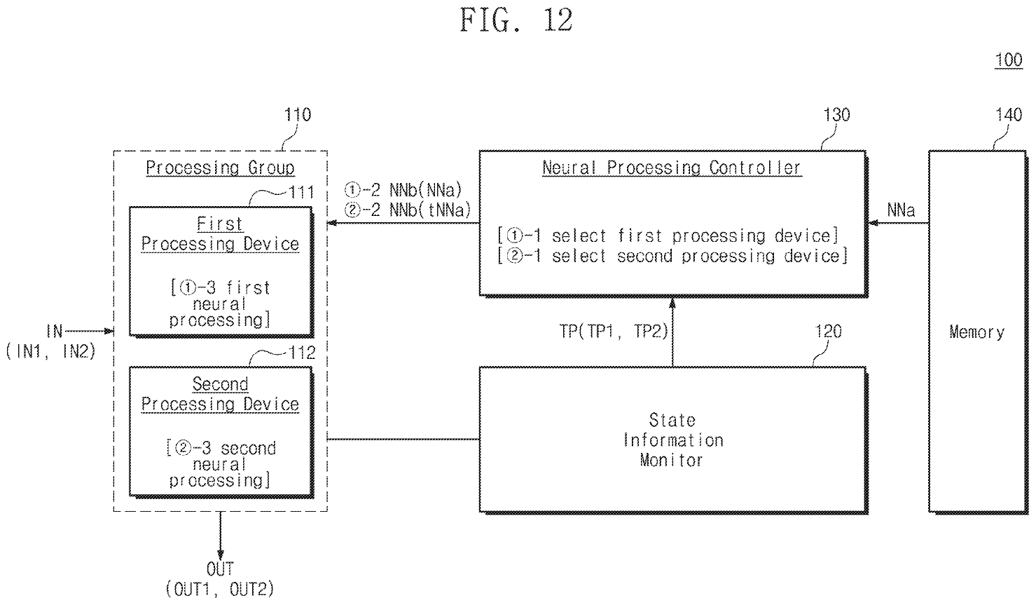

Below, an operation in which the neural processing system 100 performs a plurality of neural processing operations based on the same neural network NNa will be described with reference to FIGS. 11 and 12. For convenience of description, it is assumed that all of the operators of the neural network NNa are included in the support operators of the first processing device 111, and at least one of operators of the neural network NNa are not included in the support operators of the second processing device 112. That is, it is assumed that the first processing device 111 is capable of supporting all of the operators included in the neural network NNa, and the second processing device 112 is not capable of supporting at least one of the operators included in the neural network NNa.

FIG. 11 is a flowchart illustrating an exemplary operation of the neural processing system 100 of FIG. 1.

Referring to FIGS. 1 and 11, in operation S111, the neural processing system 100 may perform first neural processing based on the neural network NNa. For the first neural processing, the neural processing system 100 may select the first processing device 111 based on the state information SI. For example, the neural processing system 100 may select the first processing device 111 based on the event that a value of the state information SI1 of the first processing device 111 is not greater than a threshold value, and the support operators of the first processing device 111 include all of the operators of the neural network NNa. As such, the first neural processing may be performed by the first processing device 111. The first processing device 111 may perform the first neural processing to output first result data OUT1 from first input data IN1.

After the first neural processing is performed, the neural processing system 100 may perform second neural processing based on the same neural network NNa. To perform the second neural processing, in operation S112, the neural processing system 100 may determine whether the value of the state information SI1 of the first processing device 111 exceeds the threshold value. For example, the state information SI1 may change as the first neural processing is performed. As such, the state information SI1 may exceed the threshold value. As described with reference to FIGS. 7 to 10, the neural processing system 100 may determine whether one of, for example, a temperature, a voltage, a current, and a clock frequency of the first processing device 111 exceeds the threshold value.

When the value of the state information SI1 exceeds the threshold value, in operation S113, the neural processing system 100 may select the second processing device 112 for the second neural processing. In operation S114, the neural processing system 100 may transform the neural network NNa such that the second neural processing is performed by the second processing device 112. The neural processing system 100 may transform the neural network NNa to create the neural network NNb. In this case, all operators of the neural network NNb may be included in the support operators of the second processing device 112. That is, the second processing device 112 may support all of the operators included in the neural network NNb. In operation S115, the neural processing system 100 may perform the second neural processing through the second processing device 112 based on the transformed neural network NNb. The second processing device 112 may perform the second neural processing to output second result data OUT2 from second input data IN2.

Referring back to operation S112, when the value of the state information SI1 is not greater than the threshold value, in operation S116, the neural processing system 100 may select the first processing device 111 for the second neural processing. The support operators of the first processing device 111 may include all of the operators of the neural network NNa. That is, the first processing device 111 may support all of the operators included in the neural network NNa. In an exemplary embodiment, in the case in which the second neural processing is performed by the first processing device 111, the neural processing system 100 does not transform the neural network NNa. In the case in which the process of transforming the neural network NNa is omitted, the neural processing system 100 may perform the second neural processing more quickly. That is, to increase a processing speed, the neural processing system 100 may select the first processing device 111. In operation S117, the neural processing system 100 may perform the second neural processing through the first processing device 111 based on the neural network NNb, which is identical to the neural network NNa. The first processing device 111 may perform the second neural processing to output the second result data OUT2 from the second input data IN2.

FIG. 12 is a block diagram for describing an example in which the neural processing system 100 of FIG. 1 performs an operation of FIG. 11.

Referring to FIG. 12, to perform the first neural processing, the neural processing controller 130 may output the neural network NNa from the memory 140. The neural processing controller 130 may select a processing device, which will perform the first neural processing, based on the temperature information TP1 of the first processing device 111 and the temperature information TP2 of the second processing device 112. For the first neural processing, the neural processing controller 130 may select the first processing device 111 (\textcircled{1}-1).

The neural processing controller 130 may determine whether the support operators of the first processing device 111 selected include all of the operators of the neural network NNa. Based on the determination that the support operators of the first processing device 111 include all of the operators of the neural network NNa, the neural processing controller 130 may create the neural network NNb, which is identical to the neural network NNa. The neural processing controller 130 may provide the neural network NNa to the first processing device 111 (\textcircled{1}-2). The first processing device 111 may perform the first neural processing based on the neural network NNa (\textcircled{1}-3). As the first neural processing is performed, the temperature of the first processing device 111 may be increased. The state information monitor 120 may monitor a change of the temperature of the first processing device 111 to detect such an increase.

To perform the second neural processing, the neural processing controller 130 may output the neural network NNa from the memory 140. The neural processing controller 130 may determine whether the temperature information TP1 of the first processing device 111 exceeds the threshold value. When the temperature information TP1 exceeds the threshold value, the neural processing controller 130 may select the second processing device 112 for the second neural processing (\textcircled{2}-1).

The neural processing controller 130 may determine whether the support operators of the second processing device 112 selected include all of the operators of the neural network NNa. Based on the determination that the support operators of the second processing device 112 do not include at least one of the operators of the neural network NNa, the neural processing controller 130 may transform the neural network NNa to create the neural network NNb. That is, the neural network NNb may be a transformed neural network tNNa. The neural processing controller 130 may provide the transformed neural network tNNa to the second processing device 112 (\textcircled{2}-2). The second processing device 112 may perform the second neural processing based on the transformed neural network tNNa (\textcircled{2}-3). As the second neural processing is performed, the temperature of the second processing device 112 may be increased. The state information monitor 120 may monitor a change of the temperature of the second processing device 112 to detect such an increase.

As described above, according to the operation of the neural processing system 100, in the case in which neural processing is performed several times based on the neural network NNa, the neural processing may be distributed among and performed by a plurality of processing devices. In this case, the load may be distributed among the plurality of processing devices. Accordingly, it may be possible to prevent a processing device from being damaged or the operating performance from being reduced, due to, for example, a temperature increase of only one processing device.

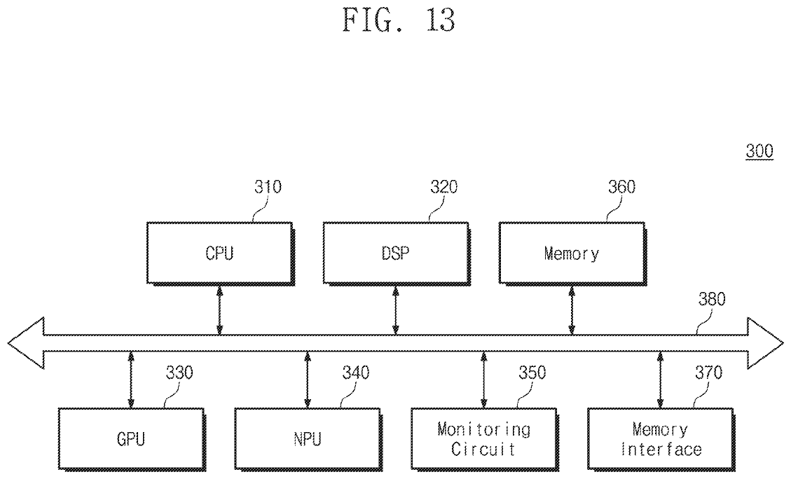

FIG. 13 is a block diagram illustrating a system on chip 300 according to an exemplary embodiment of the inventive concept.

Referring to FIG. 13, the system on chip 300 may include a central processing unit (CPU) 310, a digital signal processor (DSP) 320, a graphics processing unit (GPU) 330, a neural processing unit (NPU) 340, a monitoring circuit 350, a memory 360, a memory interface 370, and a bus 380.

The CPU 310 may control the components of the system on chip 300. That is, the CPU 310 may control the overall operation of the system on chip 300. For example, the CPU 310 may parse commands generated according to execution of an application program, and may perform various operations for processing the commands. To process the commands, the CPU 310 may directly perform an operation or may allocate the operation to the different processing devices 320, 330, and 340.

For example, the CPU 310 may include the functions of the processing devices 111, 112, 211, and 212, and the functions of the neural processing controllers 130 and 230 described with reference to FIGS. 1 to 12. The CPU 310 may select a processing device for neural processing and may transform a neural network based on support operators of the selected processing device (e.g., based on support operators supported by the selected processing device). For example, the CPU 310 may transform a neural network by driving the scheduler 12 and the compiler 13 described with reference to FIG. 5 and selecting a processing device. Also, in the case in which the CPU 310 itself is selected for the neural processing, the CPU 310 may directly perform the neural processing based on a neural network. As such, the CPU 310 may prevent the load from being focused on one processing device and may prevent performance of the neural processing from being reduced.

The DSP 320 may be a processing device for processing a digital signal at a high speed. For example, the DSP 320 may include the functions of the processing devices 111, 112, 211, and 212 described with reference to FIGS. 1 to 12. That is, the DSP 320 may perform neural processing based on a neural network provided from the CPU 310.

The GPU 330 may be a processing device for processing graphic data at a high speed. The GPU 330 may be used to process general data as well as graphic data. For example, the GPU 330 may include the functions of the processing devices 111, 112, 211, and 212 described with reference to FIGS. 1 to 12. That is, the GPU 330 may perform neural processing based on a neural network provided from the CPU 310.

The NPU 340 may be a processing device dedicated to neural processing. Various operations associated with an artificial intelligence such as, for example, deep learning or machine learning may be performed through the NPU 340. For example, the NPU 340 may include the functions of the processing devices 111, 112, 211, and 212 described with reference to FIGS. 1 to 12. That is, the NPU 340 may perform neural processing based on a neural network provided from the CPU 310.

The monitoring circuit 350 may sense state information of the CPU 310, the DSP 320, the GPU 330, and the NPU 340, or may monitor the sensed state information. The monitoring circuit 350 may provide various state information to the CPU 310. As such, the CPU 310 may select a processing device, which will perform the neural processing, based on the state information. For example, the monitoring circuit 350 may include the functions of the state information monitors 120 and 220 described with reference to FIGS. 1 to 12.

The memory 360 may store data that is used for an operation of the system on chip 300. In an exemplary embodiment, the memory 360 may temporarily store data processed or to be processed by the CPU 310. For example, the memory 360 may include the functions of the memories 140 and 240 described with reference to FIGS. 1 to 12. That is, the memory 360 may be the memory 140 or 240, and may store a neural network to be processed.

The memory interface 370 may receive data from a memory outside the system on chip 300 or may provide data to the memory outside the system on chip 300. For example, the memory outside the system on chip 300 may include the functions of the memories 140 and 240 described with reference to FIGS. 1 to 12. That is, in the case in which an external memory stores a neural network, the memory interface 370 may receive the neural network from the external memory. The memory interface 370 may provide the received neural network to a selected processing device.

The bus 380 may provide an on-chip network within the system on chip 300. For example, the bus 380 may provide a path of transmitting data and a control signal(s). For example, the CPU 310 may transmit a command to each component through the bus 380. For example, the CPU 310, the DSP 320, the GPU 330, and the NPU 340 may receive a neural network through the bus 380.

FIG. 13 illustrates an example in which the system on chip 300 includes the CPU 310, the DSP 320, the GPU 330, and the NPU 340 as a processing device. However, the inventive concept is not limited thereto. For example, the system on chip 300 may further include various other processing devices that may perform an operation associated with neural processing.

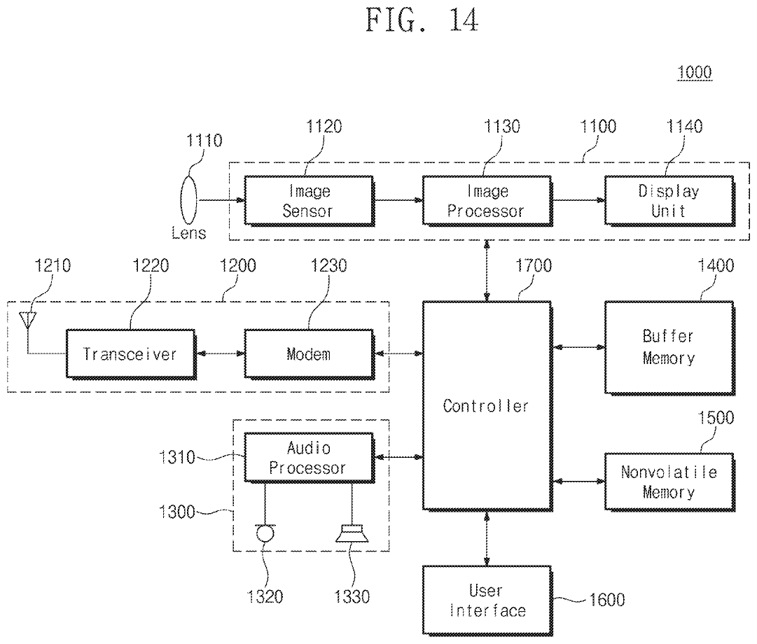

FIG. 14 is a block diagram illustrating a portable terminal 1000 according to an exemplary embodiment of the inventive concept.

Referring to FIG. 14, the portable terminal 1000 according to an exemplary embodiment of the inventive concept includes an image processing unit 1100, a wireless transceiver unit 1200, an audio processing unit 1300, a buffer memory 1400, a nonvolatile memory 1500, a user interface 1600, and a controller 1700.

The image processing unit 1100 may receive a light signal through a lens 1110. An image sensor 1120 and an image signal processor 1130 included in the image processing unit 1100 may generate image data associated with an external object based on the received light signal. A display unit 1140 may receive data from an external device (e.g., the controller 1700) and may display an image through a display panel based on the received data.

The wireless transceiver unit 1200 may exchange signals with an external device/system through an antenna 1210. A transceiver 1220 and a modem (modulator/demodulator) 1230 of the wireless transceiver unit 1200 may process signals, which are exchanged with the external device/system, in compliance with various wireless communication protocols.

The audio processing unit 1300 may process sound information by using an audio signal processor 1310, thus playing and outputting audio. The audio processing unit 1300 may receive an audio input through a microphone 1320, and may output the played audio through a speaker 1330.

The buffer memory 1400 may store data that is used for an operation of the portable terminal 1000. In an exemplary embodiment, the buffer memory 1400 may include a volatile memory such as, for example, a static random access memory (SRAM), a dynamic RAM (DRAM), or a synchronous DRAM (SDRAM), and/or a nonvolatile memory such as, for example, a phase-change RAM (PRAM), a magneto-resistive RAM (MRAM), a resistive RAM (ReRAM), or a ferroelectric RAM (FRAM). For example, the buffer memory 1400 may include the functions of the memories 140 and 240 described with reference to FIGS. 1 to 12.

The nonvolatile memory 1500 may store data regardless of whether power is being supplied to the nonvolatile memory 1500. For example, the nonvolatile memory 1500 may include at least one of various nonvolatile memories such as a flash memory, a PRAM, an MRAM, a ReRAM, and a FRAM. For example, the nonvolatile memory 1500 may include a removable memory such as a secure digital (SD) card, and/or an embedded memory such as an embedded multimedia card (eMMC). For example, the nonvolatile memory 1500 may include the functions of the memories 140 and 240 described with reference to FIGS. 1 to 12.

The user interface 1600 may arbitrate communication between a user and the portable terminal 1000. For example, the user interface 1600 may include input interfaces such as a keypad, a button, a touch screen, a touch pad, a gyroscope sensor, a vibration sensor, and an acceleration sensor. For example, the user interface 1600 may include output interfaces such as a motor and an LED lamp.

The controller 1700 may control overall operations of the components of the portable terminal 1000. The controller 1700 may be implemented with an operation processing device/circuit, which includes one or more processor cores, such as a general-purpose processor, a special-purpose processor, an application processor, or a microprocessor. For example, the controller 1700 may include the functions of the neural processing systems 100 and 200 described with reference to FIGS. 1 to 12. For example, the controller 1700 may include the function of the system on chip 300 described with reference to FIG. 13. As such, the controller 1700 may perform neural processing based on a neural network. That is, the portable terminal 1000 may provide various artificial intelligence services such as, for example, image recognition and voice recognition, by processing data through the neural processing.

According to exemplary embodiments of the inventive concept, a processing device that will perform neural processing is selected in consideration of state information of processing devices. As a result, the load may be prevented from being focused on one processing device. As such, it may be possible to prevent performance of the neural processing from being reduced or a processing device from being damaged.

Also, according to exemplary embodiments of the inventive concept, a neural network may be transformed based on operators that are supported by a selected processing device. As such, the selected processing device may perform the neural processing based on the transformed neural network.

While the inventive concept has been described herein with reference to the exemplary embodiments thereof, it will be apparent to those of ordinary skill in the art that various changes and form and detail may be made thereto without departing from the spirit and scope of the inventive concept as set forth in the following claims.

1. A method of operating a neural processing system comprising a plurality of processing devices, the method comprising:
selecting a first processing device, which will perform processing based on a neural network, from among the plurality of processing devices based on state information of the plurality of processing devices;
when at least one operator of the neural network is not supported by the first processing device, transforming the neural network into a transformed neural network based on first support operators that are supported by the first processing device; and
performing, by the first processing device, the processing based on the transformed neural network.

2. The method of claim 1, further comprising:
when all operators of the neural network are supported by the first processing device, performing the processing by the first processing device based on the neural network.

3. The method of claim 1, wherein the first support operators are not identical to second support operators that are supported by a second processing device of the plurality of processing devices.

4. The method of claim 1, wherein transforming the neural network comprises:
transforming the at least one operator of the neural network to at least one of the first support operators.

5. The method of claim 1, wherein the state information comprises temperature information of each of the plurality of processing devices, and the first processing device is selected based on the temperature information.

6. The method of claim 1, wherein the state information comprises voltage information of each of the plurality of processing devices, and the first processing device is selected based on the voltage information.

7. The method of claim 1, wherein the state information comprises current information of each of the plurality of processing devices, and the first processing device is selected based on the current information.

8. The method of claim 1, wherein the state information comprises clock frequency information of each of the plurality of processing devices, and the first processing device is selected based on the clock frequency information.

9. The method of claim 1, wherein the plurality of processing devices comprises a central processing unit (CPU), a graphic processing unit (GPU), a neural processing unit (NPU), and a digital signal processor (DSP).

10. A method of operating a neural processing system comprising a first processing device and a second processing device, the method comprising:
performing, by the first processing device, first neural processing based on a neural network;
after performing the first neural processing, when a temperature of the first processing device exceeds a threshold value, transforming the neural network into a transformed neural network based on support operators that are supported by the second processing device; and
performing, by the second processing device, second neural processing based on the transformed neural network.

11. The method of claim 10, further comprising:
when the temperature of the first processing device is not greater than the threshold value, performing the second neural processing by the first processing device based on the neural network.

12. The method of claim 10, wherein operators of the neural network are supported by the first processing device, and at least one of the operators of the neural network is not supported by the second processing device.

13. The method of claim 10, wherein transforming the neural network comprises:
transforming a first operator, which is not supported by the second processing device, from among operators of the neural network to at least one of the support operators of the second processing device.

14. The method of claim 10, wherein the temperature of the first processing device is increased by the first neural processing, and a temperature of the second processing device is increased by the second neural processing.

15. A neural processing system, comprising:
a first processing device configured to support first support operators;
a second processing device configured to support second support operators;
a state information monitor configured to monitor state information of the first and second processing devices; and
a neural processing controller configured to select a processing device, which will perform processing input data based on a neural network, from among the first and second processing devices based on the state information,
wherein, when at least one of operators of the neural network is not supported by the selected processing device, the neural processing controller is further configured to transform the neural network into a transformed neural network based on support operators of the selected processing device among the first support operators and the second support operators.

16. The neural processing system of claim 15, wherein the first support operators are not identical to the second support operators.

17. The neural processing system of claim 15, wherein the neural processing controller comprises;
a scheduler configured to select the processing device, which will perform the processing, from among the first and second processing devices based on the state information; and
a compiler configured to generate the transformed neural network by transforming the at least one operator of the neural network to at least one of the support operators of the selected processing device.

18. The neural processing system of claim 17, Wherein, when the state information of the first and second processing devices is substantially the same, the scheduler selects the processing device, which will perform the processing, based on the operators of the neural network and the first and second support operators.

19. The neural processing system of claim 17, wherein the compiler creates the transformed neural network with reference to a table comprising information about the first and second support operators.

20. The neural processing system of claim 15, wherein the state information comprises at least one of temperature information, voltage information, current information, and clock frequency information.

21-23. (canceled)
